(19) United States
(12) Patent Application Publication
(10) Pub. No.: US 2014/0057706 A1
(43) Pub. Date: Feb. 27, 2014

(54) REMOTE BETTING IN LIVE GAMES

(71) Applicant: Las Vegas Sands Corp., Las Vegas, NV (US)

(72) Inventor: Timothy MERRILL, Las Vegas, NV (US)

(73) Assignee: Las Vegas Sands Corp., Las Vegas, NV (US)

(21) Appl. No.: 14/011,627

(22) Filed: Aug. 27, 2013

Related U.S. Application Data
(60) Provisional application No. 61/693,555, filed on Aug. 27, 2012.

(51) Int. Cl. G07F 17/32

(52) U.S. Cl. CPC G07F 17/3244
USPC 463/25

(57) ABSTRACT

In one aspect, a method for remote betting is provided, the method including identifying one or more open live games available for betting, receiving a betting request from a user to place one or more bets on one or more outcomes of one or more games of the one or more open live games, determining an outcome of the one or more games, wherein the outcome of the game is determined based on real-time gaming information received from one or more sources and initiating a financial transaction to settle the one or more bets placed by the user at least in part based on the determine outcome of the one or more games.

### CROSS-REFERENCE TO RELATED APPLICATION

The present application claims the benefit of U.S. Provisional Patent Application Ser. No. 61/693,555, entitled “Remote Betting in Live Tables Games,” filed on Aug. 27, 2012, which is hereby incorporated by reference in its entirety for all purposes.

### BACKGROUND

Wagers or bets may be placed by a user on various outcomes of a game or other betting events. In one example, wagers may for example be placed on casino games, sports games, financial transactions such as derivatives and binary options, or other instances where wagering on outcome of an event is possible. In one example, a wager or bet comprises a monetary value being placed on an event occurring within the game. A payout is often associated with a wager, wherein the payout is in some examples, at least in part, based on the odds of the wagered event occurring within the game or other event.

### SUMMARY

The disclosed subject matter relates to a machine-implemented method for remote betting, the method comprising identifying one or more open live games available for betting. The method further comprises receiving a betting request from a user to place one or more bets on one or more outcomes of one or more games of the one or more open live games. The method further comprises determining an outcome of the one or more games, wherein the outcome of the game is determined based on real-time gaming information received from one or more sources and initiating a financial transaction to settle the one or more bets placed by the user at least in part based on the determine outcome of the one or more games.

The disclosed subject matter also relates to a system for remote betting, the system comprising a user input device for receiving a betting request from a user to place one or more bets on one or more outcomes of one or more games of one or more open live games. The system further comprising one or more processors and a machine-readable medium comprising instructions stored therein, which when executed by the processors, cause the processors to perform operations. The operations comprise identifying a plurality of live games. The operations further comprise selecting the one or more open live games available for betting from the plurality of live games based on real-time information regarding the plurality of live games. The operations further comprise determining an outcome of the one or more games, wherein the outcome of the game is determined based on real-time gaming information received from one or more sources and initiating a financial transaction to settle the one or more bets placed by the user at least in part based on the determined outcome of the one or more games.

The disclosed subject matter also relates to a non-transitory machine-readable medium including instructions stored therein, which when executed by a machine, cause the machine to perform operations. The operations include tracking real-time gaming information regarding a plurality of live games according to real-time information received from a plurality of sources. The operations further include identifying one or more open games of the plurality of live games open for betting based on the real-time information. The operations further include receiving a betting request from a user, the betting request comprising a request to place at least one bet on an outcome of at least one game of the one or more open games. The operations further include determining an outcome of the at least one game based on the tracked real-time gaming information and initiating a financial transaction based on the determination of outcome.

It is understood that other configurations of the subject technology will become readily apparent from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several implementations of the subject technology are set forth in the following figures.

FIG. 1 illustrates an example client-server network environment, which provides for facilitating remote betting in live games.

FIG. 2 illustrates a flow diagram of an example process for facilitating remote betting in live games.

FIG. 3 illustrates a screen shot of an example graphical user interface providing one or more open games for display to the user to facilitate remote betting in live games.

FIG. 4 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent that the subject technology is not limited to the specific details set forth herein and may be practiced without these specific details.

The subject disclosure facilitates remote betting in live games. The term “games” as used herein encompasses various opportunities for a user or player to wager or bet on the results or outcome of an event, and/or on a specific occurrence. For example, wagering may occur in games such as casino games, sporting events, financial events such as stock market (e.g., derivatives, binary options, etc.) or other instances in which a user may wager or bet on an occurrence or outcome of an event. In one example, the outcome may be associated with odds, and further may be associated with a payout payable with the event wagered on occurs. In one example, the payout may be calculated based on the amount of the bet and/or the odds.

In some implementations, live games may refer to games being conducted in real-time and in a physical setting. For example, in live games a user may place bets on real-time events at the physical game being played and the outcome is reported as it is occurring. Live games may refer to non-virtual games, such that the game is occurring at a physical location (e.g., operated by or affected by physical entities such as other players, dealers, operators physically present). In one example, a live game is distinct from a virtual game occurring in the virtual world.

Live games may include single player or multi-player games, where wagers may be placed on the outcome by one or more users (e.g., players). Odds of winning the bet and/or the payout of a bet placed on a game may be dependent on or independent from the number of players in the game. In one example, any number of players wagering on the game may be personally located at the game and/or may place a wager remotely according to the processes described herein.

The term “remote” as used herein refers to any wagering performed by a user using an application instead of physically being present at the game and using the physical means for wagering on the game. In some embodiments, the user may be geographically proximate to the actual location where the game is being conducted, while in other embodiments, the geographic location of the user is remote from the location of the actual game.

In some implementations, remote betting in live games may include tracking real-time gaming information regarding one or more live games (e.g., table games, sporting events, financial transactions). In some examples, a remote betting session is initiated, and/or conducted in response to receiving a request from a user. In response to the request, one or more live games open for wagering may be identified. In on example, a selection is received to place bets on one or more open games. An outcome of the placed bets are then determined based on the tracked real-time gaming information, and a financial transaction is performed based on the determination of the outcome.

In one example, remote betting in live games may be facilitated using a client application. In one example, the client application may be installed at a client device and/or otherwise accessible at a client device by a user (e.g., through a browser installed at the client device). In an exemplary embodiment, the user may download the application onto a client device and/or access the application using a browser installed at the client device. If the user is a new player, the user may be requested to provide information such as name, contact information, gaming preferences, and/or financial information. Such information may be used to create a user account used to conduct remote betting in live games. Financial information may be used to fund the betting account such that the user may place wagers. The account may be maintained in accordance with applicable requirements, rules and/or regulations for gaming and/or financial accounts.

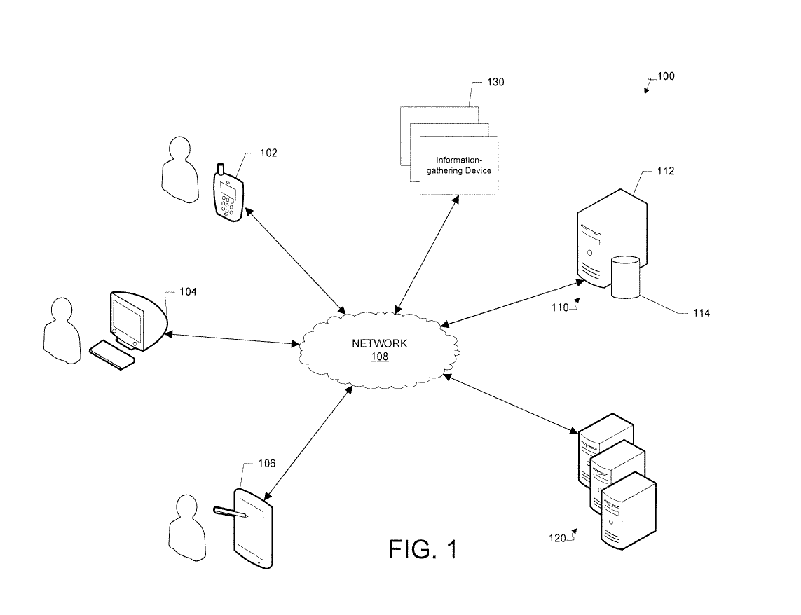

FIG. 1 illustrates an example client-server network environment, which provides for facilitating remote betting in live games. A network environment 100 includes a number of electronic devices 102, 104, 106 and/or or more information gathering devices 130 communicably connected to a server 110 and/or one or more servers 120 by a network 108.

In some example implementations, electronic devices 102, 104, 106 can be computing devices such as general purpose computers including laptop or desktop computers, portable computing devices, smartphones, PDAs, portable media players, tablet computers, or other appropriate computing devices. In the example of FIG. 1, electronic device 102 is depicted as a smartphone, electronic device 104 is depicted as a desktop computer and electronic device 106 is depicted as a PDA.

In one example, the client devices 102, 104, 106 can be any computing device capable of communicating over a communication network. In one example, electronic devices 102, 104 and/or 106 may be configured to access data from other storage media, such as memory cards or disk drives as may be appropriate in the case of downloaded services. Client devices 102, 104, 106 may include standard hardware computing components such as network and media interfaces, non-transitory computer-readable storage (memory), and processors for executing instructions that may be stored in memory.

In some implementations, server 110 includes a processing device 112 and a data store 114. Processing device 112 executes computer instructions stored in data store 114, for example, to facilitate remote betting in live games for users (“players”) interacting with electronic devices 102, 104, 106. In one example, the system may further comprise one or more other remote servers performing various functionalities and/or storage capabilities described herein with regard to the server 110 either alone or in combination with server 110. Server 110 may be in communication with one or more remote servers 120 either through the network 108 or through another network or communication means.

In some example aspects, server 110 and/or one or more remote servers 120 can be a single computing device such as a computer server. In other implementations, server 110 and/or one or more remote servers 120 can represent more than one computing device working together to perform the actions of a server computer (e.g., cloud computing). Server 110 and/or one or more remote servers 120 may be coupled with various remote databases or storage services. While server 110 and the one or more remote servers 120 are described as being remote from one another, it should be understood that the functions performed by these servers may be performed within a single server, or across multiple servers.

Server 110 and/or one or more remote servers 120 may include any type of server or other computing device as is known in the art, including standard hardware computing components such as network and media interfaces, non-transitory computer-readable storage (memory), and processors for executing instructions or accessing information that may be stored in memory. The functionalities of multiple servers may be integrated into a single server. Any of the aforementioned servers (or an integrated server) may take on certain client-side, cache, or proxy server characteristics. These characteristics may depend on the particular network placement of the server or certain configurations of the server.

In one example, server 110 and/or one or more remote servers 120 are in communication with one or more information gathering devices 130. The communication may be facilitated using wired or wireless communication. In one example, the servers and information gathering devices 130 may communicate through the network 108. Information gathering devices 108 may be facilitated to determine information regarding the outcome of games at one or more locations where games are taking place. Information-gathering devices 130 may include various devices such as cameras, sensors (e.g., motion, audio), input devices (e.g., operator or dealer input devices, secure card result devices), RFID tags, scanners or any similar devices configured to or capable of determining information regarding games (e.g., real-time game outcomes). In one example, the information-gathering devices may be configured to communicate such information (e.g., directly and/or indirectly through remote servers 120 or another device) to server 110.

Users may interact with the system hosted by server 110, and/or one or more remote servers 120, through a client application installed at the electronic devices 102, 104, 106. Alternatively, the user may interact with the system through a web based browser application at the electronic devices 102, 104, 106. Communication between client devices 102, 104, 106 and the system (e.g., server 110 and/or one or more remote servers 120), may be facilitated through a network (e.g., network 108). Communications between the client devices 102, 104, 106, server 110 and/or one or more remote servers 120 may be facilitated through the various communication protocols (e.g., HTTP, XMPP).

Network 108 can be a public communication network (e.g., the Internet, cellular data network, dialup modems over a telephone network) or a private communications network (e.g., private LAN, leased lines). The network 108 can include, for example, any one or more of a personal area network (PAN), a local area network (LAN), a campus area network (CAN), a metropolitan area network (MAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

Upon opening or otherwise initiating the application, the client device (e.g., devices 102, 104, 106) may communicate with the system (e.g., at server 110) to determine what games may be open to receiving bets. The system (e.g., at server 110) may receive and maintain real-time information regarding a number of live games. Such information may be gathered by a variety of devices (e.g., information gathering devices 130), including cameras, scanners (e.g., card scanners, shoe scanners), sensors, RFID tags, dealer or operator input devices, and other devices known in the art for tracking information.

In some implementations, the client device receives a list of one or more games open for betting from the server 110 and provides the list for display to the user. Where the user has expressed certain preferences or criteria or the system is otherwise aware of such preferences or criteria, the list may be filtered based on the same, such that the user may view only those games that are likely to be of interest. The criteria may include type of game, location of game, timing restrictions on betting, trends, denominations, or other characteristics of the game. For example, with respect to table games in a casino filter criteria may include game type, casino, denomination, trends, and various other characteristics of live table games. Based on the real-time gaming information, the games presented to the user may include games open for betting and/or meeting the user criteria.

Upon being presented with a list of open games, the user may enter a bet in one or more games. In some instances, the user may be given the option to place multiple bets at once. The bet information may be received by the application (e.g., sent to server 110). Once the real-time gaming information is received (e.g., at server 110) regarding the outcome of the game, the system (e.g., at server 110) may determine whether the bet was won or lost according to the outcome of the game. Subsequently, the system initiates a financial transaction based on the determination of whether the bet was won or lost. If the bet was won, an amount may be deposited in the betting account associated with the user. If the bet was lost, an amount may be debited from the betting account associated with the user.

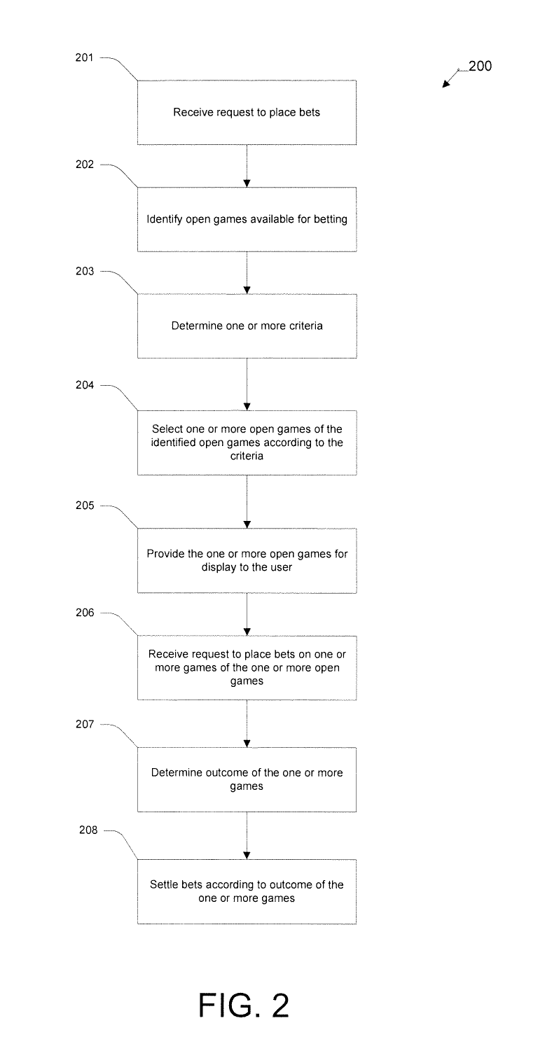

FIG. 2 illustrates a flow diagram of an example process 200 for facilitating remote betting in live games. In step 201, a request is received to place bets. In one example, the request is received when a user logs into, or otherwise initiates the application at the user client device (e.g., electronic device 102, 104 or 106). In one example, the user may make a selection within the application running on the client device indicating a request to place bets and/or see open games available for bets.

In step 202, open games available for betting are identified. In one example, the system (e.g., at server 110) is in communication with one or more information-gathering devices (e.g., device 130). The system identifies games where betting is available (“open games”). In one example, the system is tracking real-time information regarding a plurality of live games and identifies live games open for betting according to the real-time information. In some examples, there may be timing restrictions associated with one or more games provided for display, such that a user may have a limited amount of time to place the bet before a game closes to bets (e.g., remote bets). The system uses information to determine games in a window of time where betting is allowed by a user. In another example, the information-gathering device may be configured to report whether a game associated with the device is open for betting. In one example, the information regarding live games includes real-time information received from one or more sources (e.g., information gathering devices, or other devices/sources).

In step 203, one or more criteria are identified for selecting games. In one example, a user may indicate criteria or preferences for selecting games. In some examples, one or more criteria may be derived from historical information regarding the user (e.g., user betting history, preferences, account, etc.). In one example, the criteria may include manually entered criteria by the user either at the time of requesting to bet on games and/or at any time prior to the request (e.g., preferences stored in the user account). In another example, the criteria may include criteria automatically selected by the system (e.g., based on historical information of the user or similar users, available odds, etc.). In one example, the criteria may for example include type of game, location of game, timing restrictions on betting, payout amount, odds, trends, denominations, or other characteristics of the game.

In one example, the system has access to information and characteristics regarding each live game and thus may compare the information to the criteria to determine which games meet the criteria. In one example, some information may be determined by the system according to real-time information regarding the plurality of live games being tracked by the system (or one or more other systems). Trends may be derived according to historical outcomes of a game (e.g., the game having been conducted previously). A game may be defined by its location, or other properties. For each unique game, historical information may be accessible to determine trends. For example, real-time information regarding a game within a defined period of time may be used to determine trends. In one example, trends may for example include number of times a specific event has occurred within the game, the amount or odds of the game so far, or within a specific time period, or other such information regarding previous outcome of the game.

In another example, game selection may be based on a specific odd selection. For example, the system may be configured to determine real-time odds for any combination of games. A user may desire a specific payout when a specific event occurs within a game. The system may be configured to select a combination of games which provide odds that would provide such payout if the game is won.

In step 204, one or more open games are selected from the open games identified in step 202 according to the criteria determined in step 203. For example, the criteria determined in step 203 is compared to the characteristics of the open games identified in step 202 to determine the one or more open games that meet the criteria. In one example, no additional criteria may be presented and selection of live games may be based on the fact that the games are available for receiving bets.

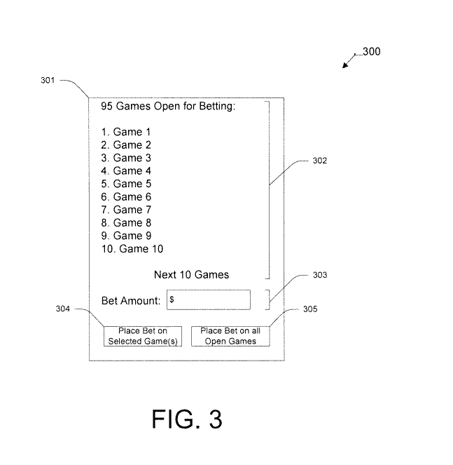

In step 205, the selected one or more open games are provided for display to the user. FIG. 3, described in more detail below, displays an example user interface providing a listing of open games for display to the user.

Once the user is able to view the open games, the user may select to place bets on one or more of the displayed one or more open games. In one example, a user may place one or more bets on one or more of the displayed one or more open games. For example, the user may choose to place a bet for a certain outcome on all or some of the one or more open games. In another example, the user may place multiple bets for various occurrences within one or more of the open games.

In step 206, a request to place bets on one or more games of the one or more open games is received. The system keeps track of the bets placed. In one example, the system is configured to calculate the odds for each placed bet. In one example, the calculation may be in real-time.

In step 207, the outcome of the one or more games is determined. As described above, the system is coupled to information gathering devices. The information gathering devices are configured to provide real-time information regarding the outcome of the one or more games to the system. The outcome of the one or more games is received, based on the bets and/or the odds for the bets and/or the games (e.g., the calculated odds) the system determines a specific payout.

In step 208, the bets rare settle according to the outcome of the one or more games. If the system determines that an amount should be paid out to the user (e.g., according to the outcome of the bets and/or the odds), the system initiates a financial transaction to pay the amount. In one example, the system may also subtract the bet amount from the user and/or may settle the difference between the bet and any payout owed to the user. In one example, the system maintains a funded betting account associated with the user, and the financial transaction involves depositing and/or debiting an amount indicated by the betting request and/or the payout from the funded betting account.

FIG. 3 illustrates a screen shot of an example graphical user interface 300 providing one or more open games for display to the user to facilitate remote betting in live games. Graphical user interface 300 includes a window 301 provided for display to the user including a list 302 of games open for betting. A bet entry box 303 is provided for the user to enter a bet amount. In this example, the user is able to place the bet on one or more selected games by selecting button 304 or to place the bet on all available games by selecting button 305. It should be understood that other betting selection may be available. For example, in some implementations, a drop down list may be available with different selections for the user. In one example, the user may also be provided with means for entering the event which the user wishes to bet on when one or more different events may be wagered on in a game.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

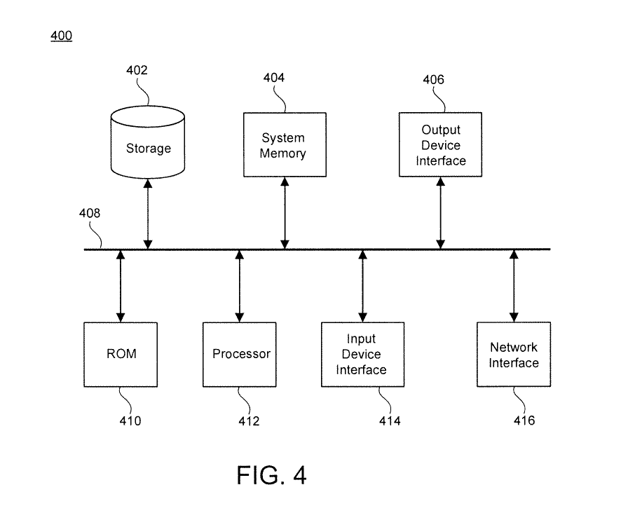

FIG. 4 conceptually illustrates an electronic system with which some implementations of the subject technology are implemented. Electronic system 400 can be a server, computer, phone, PDA, laptop, tablet computer, television with one or more processors embedded therein or coupled thereto, or any other sort of electronic device. Such an electronic system includes various types of computer readable media and interfaces for various other types of computer readable media. Electronic system 400 includes a bus 408, processing unit(s) 412, a system memory 404, a read-only memory (ROM) 410, a permanent storage device 402, an input device interface 414, an output device interface 406, and a network interface 416.

Bus 408 collectively represents all system, peripheral, and chipset buses that communicatively connect the numerous internal devices of electronic system 400. For instance, bus 408 communicatively connects processing unit(s) 412 with ROM 410, system memory 404, and permanent storage device 402.

From these various memory units, processing unit(s) 412 retrieves instructions to execute and data to process in order to execute the processes of the subject disclosure. The processing unit(s) can be a single processor or a multi-core processor in different implementations.

ROM 410 stores static data and instructions that are needed by processing unit(s) 412 and other modules of the electronic system. Permanent storage device 402, on the other hand, is a read-and-write memory device. This device is a non-volatile memory unit that stores instructions and data even when electronic system 400 is off. Some implementations of the subject disclosure use a mass-storage device (such as a magnetic or optical disk and its corresponding disk drive) as permanent storage device 402.

Other implementations use a removable storage device (such as a floppy disk, flash drive, and its corresponding disk drive) as permanent storage device 402. Like permanent storage device 402, system memory 404 is a read-and-write memory device. However, unlike storage device 402, system memory 404 is a volatile read-and-write memory, such a random access memory. System memory 404 stores some of the instructions and data that the processor needs at runtime. In some implementations, the processes of the subject disclosure are stored in system memory 404, permanent storage device 402, and/or ROM 410. For example, the various memory units include instructions for facilitating remote betting in live games according to various implementations. From these various memory units, processing unit(s) 412 retrieves instructions to execute and data to process in order to execute the processes of some implementations.

Bus 408 also connects to input and output device interfaces 414 and 406. Input device interface 414 enables the user to communicate information and select commands to the electronic system. Input devices used with input device interface 414 include, for example, alphanumeric keyboards and pointing devices (also called “cursor control devices”). Output device interfaces 406 enables, for example, the display of images generated by the electronic system 400. Output devices used with output device interface 406 include, for example, printers and display devices, such as cathode ray tubes (CRT) or liquid crystal displays (LCD). Some implementations include devices such as a touchscreen that functions as both input and output devices.

Finally, as shown in FIG. 4, bus 408 also couples electronic system 400 to a network (not shown) through a network interface 416. In this manner, the computer can be a part of a network of computers (such as a local area network (“LAN”), a wide area network (“WAN”), or an Intranet, or a network of networks, such as the Internet. Any or all components of electronic system 400 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that some illustrated steps may not be performed. Some of the steps may be performed simultaneously. For example, in certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

What is claimed is:

1. A method for remote betting, the method comprising:
identifying one or more open live games available for betting;
receiving a betting request from a user to place one or more bets on one or more outcomes of one or more games of the one or more open live games;
determining an outcome of the one or more games, wherein the outcome of the game is determined based on real-time gaming information received from one or more sources; and
initiating a financial transaction to settle the one or more bets placed by the user at least in part based on the determine outcome of the one or more games.

2. The method of claim 1, wherein the identifying one or more live games comprises:
identifying a plurality of live games available for betting;
determining one or more criteria for selecting games; and
selecting the one or more open live games from the plurality of live games based on the one or more criteria.

3. The method of claim 2, wherein the criteria comprises one or more user indicated criteria.

4. The method of claim 3, wherein the user indicated criteria comprises one or more of type of game, location of game, timing restrictions on betting, payout amount, odds, trends, or denominations.

5. The method of claim 1, further comprising:
evaluating the real-time gaming information regarding the one or more games received within a predetermined period of time to identify a trend.

6. The method of claim 1, further comprising maintaining a funded betting account associated with the user, wherein the financial transaction involves depositing or debiting an amount indicated by the betting request from the funded betting account.

7. The method of claim 1, wherein the live games may be one or more of casino table games, live sporting events or financial transactions.

8. The method of claim 1, wherein the outcome of the game is determined based on information received from one or more information gathering devices providing real time information regarding the outcome of the live game.

9. The method of claim 8, wherein the information gathering devices comprise one or more of cameras, sensors, scanners, RFID tags, input devices, or result devices.

10. The method of claim 1, further comprising tracking real-time gaming information regarding a plurality of live games according to the outcome information received from the one or more sources, wherein the identifying the one or more open live games is based on the real-time gaming information.

11. The method of claim 1, further comprising:
providing the one or more open live games for display to the user, and receiving a selection of the one or more games from the user.

12. The method of claim 1, further comprising:
calculating an odd associated with each bet of the one or more bets of the betting request in real time and calculating a payout according to the outcome of the one or more games and the odd.

13. The method of claim 12, wherein the financial transaction comprises crediting the user with the payout when it is determined that the user has won at least one bet of the one or more bets.

14. A system for remote betting, the system comprising:
a user input device for receiving a betting request from a user to place one or more bets on one or more outcomes of one or more games of one or more open live games; and
one or more processors; and
a machine-readable medium comprising instructions stored therein, which when executed by the processors, cause the processors to perform operations comprising:
identifying a plurality of live games;
selecting the one or more open live games available for betting from the plurality of live games based on real-time information regarding the plurality of live games;
determining an outcome of the one or more games, wherein the outcome of the game is determined based on real-time gaming information received from one or more sources; and
initiating a financial transaction to settle the one or more bets placed by the user at least in part based on the determined outcome of the one or more games.

15. The system of claim 14, further comprising one or more devices for tracking the real-time gaming information regarding the plurality of live games.

16. The system of claim 15, wherein the one or more devices comprise one or more of cameras, RFID tags, dealer input devices, secure card result devices or other similar devices.

17. The system of claim 14, wherein the user input device is implemented using a user client device running a client application.

18. The system of claim 16, wherein the client device further comprises a user display device for providing the one or more open live games for display to the user.

19. The system of claim 14, wherein selecting the one or more open live games further comprises:
determining one or more criteria for selecting games; and
selecting the one or more open live games from the plurality of live games based on the one or more criteria.

20. A non-transitory machine-readable medium comprising instructions stored therein, which when executed by a machine, cause the machine to perform operations comprising:
tracking real-time gaming information regarding a plurality of live games according to real-time information received from a plurality of sources;
identifying one or more open games of the plurality of live games open for betting based on the real-time information;
receiving a betting request from a user, the betting request comprising a request to place at least one bet on an outcome of at least one game of the one or more open games;
determining an outcome of the at least one game based on the tracked real-time gaming information; and
initiating a financial transaction based on the determination of outcome.
